(19) United States
(12) Patent Application Publication
(10) Pub. No.: US 2009/0040071 A1
(43) Pub. Date: Feb. 12, 2009

(54) Method for the Determination of an Optimal Runway Lighting Intensity

(76) Inventor: Klaus Heyn, Hamburg (DE)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 12/084,339

(22) PCT Filed: Nov. 6, 2006
(86) PCT No.: PCT/DE2006/001959

§ 371 Date: Apr. 29, 2008

(30) Foreign Application Priority Data
Nov. 9, 2005 (DE) 10 2005 053 899.1

(51) Int. Cl. B64F 1/18

(52) U.S. Cl. 340/953

(57) ABSTRACT

The invention is directed to a method for determining an optimal runway lighting intensity based on the determination of an optimal lighting intensity for a configurable target value of the runway visual range taking into account the runway-specific parameters of the lighting system, the meteorological optical range, and the background brightness. It is the object of the invention to provide a method by which it is possible to significantly reduce the energy consumption of a runway lighting system by specific control of the energy supply from economic and ecological view points and by fully taking into account all safety-related aspects.

### CROSS-REFERENCE TO RELATED APPLICATIONS

This is a national phase application of International Application No. PCT/DE2006/001959, filed Nov. 6, 2006 which claims priority of German Application No. 10 2005 053 899.1, filed Nov. 9, 2005, the complete disclosures of which are hereby incorporated by reference.

### BACKGROUND OF THE INVENTION

a) Field of the Invention

The invention is directed to a method for determining an optimal runway lighting intensity based on the determination of an optimal lighting intensity for a configurable target value of the runway visual range taking into account the runway-specific parameters of the lighting system, the meteorological visibility, and the background brightness.

b) Description of the Related Art

For flight operations under unfavorable visual conditions, at twilight, and at nightfall, runways in airports are routinely outfitted with illumination arrangements for marking the edges of the runway (edge lights) and, when required by category, for marking the center of the runway (center line lights) (ICAO Annex 14—Aerodromes). These illumination arrangements have a particular light distribution and are oriented at defined angles to the approach direction. The landing pilot orients himself substantially to these lighting arrangements under the above-mentioned conditions in order to set the aircraft down in the center of the runway.

The visibility of the runway lighting under different daylight conditions and weather conditions is described by a calculated runway visual range RVR. Depending on the category of the airport, different lower limits at which a landing may still be carried out are used for the RVR (ICAO Annex 6—Operation of Aircraft).

| | |
|---|---|
| CAT I | 550 m |
| CAT II | 350 m |
| CAT III | 200 m |
| CAT IIIb | 050 m |

The calculation of the RVR takes into account:
the meteorological optical range MOR determined by transmissometers or forward scattering sensors
the determined background brightness (luminance of the background) against which the runway lighting must be seen (BGL, Background Luminance)
the light intensity distribution of the runway lighting determined by type, position and orientation of the illumination arrangements, and
the adjustable light intensity of the runway lighting system.

The runway lighting is normally put into operation at the onset of twilight. The intensity of the runway lighting is selected by the ATC personnel (Air Traffic Controller) based on empirical values corresponding to the prevailing background brightness and under conditions of limited visibility.

Often, “precautionary” settings with an unnecessarily high intensity are selected because they always ensure the greatest possible contrast for the visibility of the runway lighting.

A so-called RVR computer system with direct display of results in the tower allows the ATC personnel to assess the resulting runway visual range and, as the case may be, to initiate the necessary steps for additional safety measures or suspend flight operations.

The manually adjusted intensity of the runway lighting is communicated to the RVR computer system usually by means of an appropriate data interface from the runway lighting system or is determined by a suitable measurement (e.g., operating current of the lighting means).

The adjustment of the runway lighting intensity was previously carried out exclusively manually. Continuous adjustments and freely programmable intensity steps or intensity steps which are selectable by buttons are known.

As was already described, the calculation of the RVR takes into account different parameters which are acquired by measurements on the one hand and are fixedly preset depending on the installation and the runway on the other hand.

Apart from background brightness BGL (indicated in cd/m²) which is converted into a visibility threshold Et (indicated in lux), the meteorological optical range MOR (indicated in m), the contrast between the lamp and background K (defined at 5% to ensure visibility in every case), and the light intensity I₀ (indicated in cd) as a function of the distance R (indicated in m) between the lamp and the pilot are included in the calculation of lamp visibility R.

In order to calculate the runway visual range from the lamp visibility R, the influence of the position and radiating characteristics of the runway lighting in relation to the observation angle of the pilot on approach must also be taking into account. This influence is already taken into account in the determination of the runway lighting light intensity distribution I₀[R] so that the lamp visibility R is a direct measure for the runway visual range RVR (see FIG. 1).

Since the formula for the calculation of the RVR cannot be solved in a closed manner, the determination of the RVR is carried out by means of an iterative process.

In the RVR computer system, the measured MOR is entered in Equation 1, and R is changed taking into consideration the light intensity resulting from the function I₀[R] until equality is met.

MOR=(InK*R)/(In((Et*R²)/(D*I₀[R]))) (Equation 1)

The contrast threshold K is set at 0.05 in conformity to the recommendations of the International Civil Aviation Organization (ICAO Manual of Runway Visual Range Observing and Reporting Practices, Doc. 9328-AN/908). It determines the minimum contrast at which an object can still be discerned against a background.

The measured background brightness is transformed continuously or by steps into a visibility threshold (eye threshold) Et by means of a corresponding assignment rule according to ICAO (Manual of Runway Visual Range Observing and Reporting Practices, Doc. 9328-AN/908) and is entered in Equation 1. FIG. 2 shows the corresponding stepwise assignment rule. By including the observation angle of the pilot on approach, R can be equated to RVR. The typical observation angle is already incorporated in the function I₀[R].

Taking into account the particulars mentioned above, the general equation (1) can now be made more specific:

MOR=(In0.05*RVR)/(In((Et*RVR²)/(D*I₀[RVR]))) (Equation 2)

Depending upon the value selected for RVR, the corresponding value for I₀[RVR] is taken from an assignment rule which takes into account the lighting-specific parameters of the runway and the typical observation angle of the pilot on approach. The respective intensity adjustment of the runway lighting influences the value of I₀[RVR] by the intensity dimming D (here, 1 corresponds to a lighting intensity of 100%). FIG. 3 shows a corresponding assignment example.

Depending on the instantaneous background brightness, fixed relationships result between the measured MOR and the resulting RVR taking into account the adjusted intensity of the runway lighting.

Referring to the assignment example for I₀[RVR] from FIG. 3, FIG. 4 shows the relationship for RVR as a function of the MOR for the selected background brightness situations: nighttime, twilight, daytime, bright daylight, and for a lighting intensity adjustment of 100%.

After the RVR determined in conformity to the ICAO recommendations (ICAO Manual of Runway Visual Range Observing and Reporting Practices, Doc. 9328-AN/908) has been scaled and corresponding averages and trends have been calculated, the results are presented to the ATC personnel for further use.

The energy consumption of the runway lighting arrangements in airports is a serious operational cost factor. The quantity of necessary lighting bodies adds up to many thousands of individual elements particularly in large airports. Accordingly, the yearly energy consumption of an installation of this kind for an international airport adds up to several thousand megawatt hours.

### OBJECT AND SUMMARY OF THE INVENTION

It is the primary object of the invention to provide a method by which it is possible to significantly reduce the energy consumption of a runway lighting system by means of specific control of the energy supply from economic and ecological view points and by fully taking into account all safety-related aspects.

According to the invention, this object is met by a method for determining and tracking the runway lighting intensity based on the determination of an optimal lighting intensity for a target value of the runway visual range RVR taking into account the runway-specific parameters of the lighting system, the meteorological optical range, and the background brightness in that the measured values for the meteorological optical range MOR and the background brightness and the runway-specific and lighting system-specific light intensity distribution of the lighting taking into account the observation angle of the pilot on approach, and a minimum runway lighting intensity are provided to a computer system, in that a visibility threshold is determined within the computer system based on the measured background brightness, in that an optimal factor for the intensity dimming of the runway lighting is calculated within the computer system using the measured MOR, the calculated visibility threshold, the runway-specific and lighting system-specific light intensity of the lighting distribution taking into account the observation angle of the pilot on approach, and the minimum runway lighting intensity, which optimal factor ensures an RVR corresponding to the target value insofar as permitted by the environmental parameters, and in that the determined optimal factor for the intensity dimming is provided by way of a suitable data interface and/or display for determining and tracking the runway lighting intensity.

The invention will be described more fully in the following with reference to embodiment examples.

### BRIEF DESCRIPTION OF THE DRAWINGS

In the drawings:

FIG. 1 shows an overview for calculating the RVR;

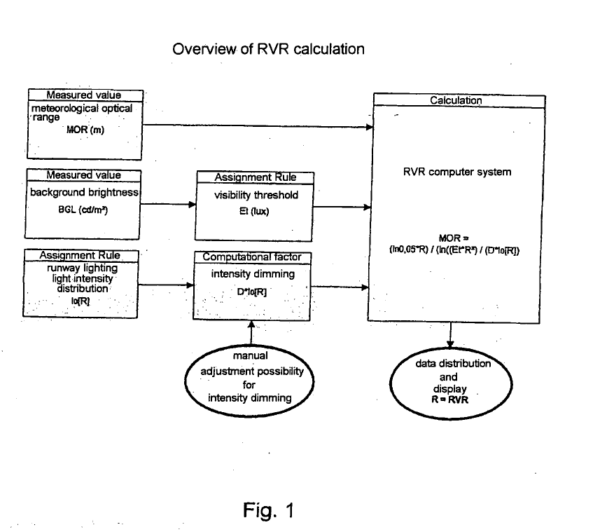

FIG. 2 shows background brightness/visibility threshold assignment rule;

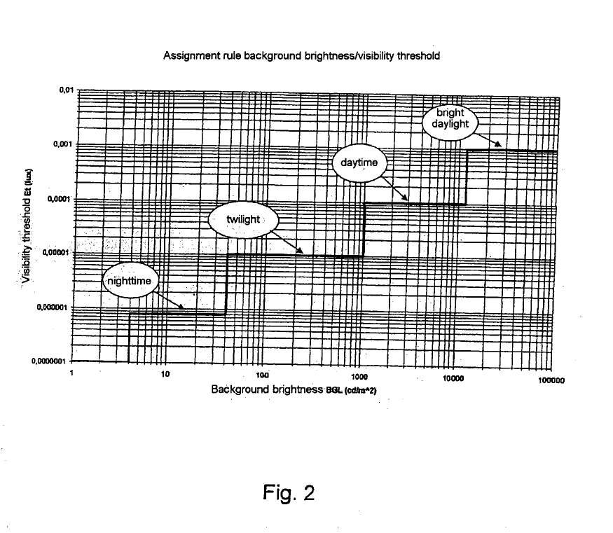

FIG. 3 is a graph showing the light intensity I₀ of runway lighting as a function of the RVR;

FIG. 4 is a graph showing the relationship between MOR and RVR with different background brightnesses;

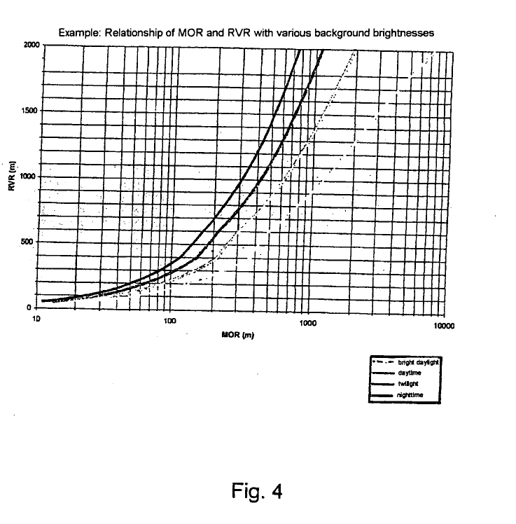

FIG. 5 shows an overview of the RVR calculation and determination of the optimal intensity dimming D_{OPT} with semiautomatic control of the runway lighting intensity;

FIG. 6 shows an overview of the RVR calculation and determination of the optimal intensity dimming D_{OPT} with fully automatic control of the runway lighting intensity;

FIG. 7 shows the automatic tracking of the lighting intensity for RVR=1500 m;

FIG. 8 shows the MOR change and resulting RVR with automatic lighting intensity tracking for different background brightnesses;

FIG. 9 shows the automatic tracking of the lighting intensity over time for different background brightnesses; and

FIG. 10 shows the energy saving potential for various background brightnesses.

### DESCRIPTION OF THE PREFERRED EMBODIMENTS

Building upon the prior art, the method according to the invention makes use of the possibility of assessing the RVR resulting from a determined runway lighting intensity and, based on this knowledge, tracking the runway lighting intensity in a semiautomatic or fully automatic manner in such a way that the resulting RVR always dependably adopts a configured target value RVR_{ZIEL} insofar as permitted by the meteorological optical range and the background brightness of this configured target value.

In this way, it can be ensured that the intensity of the runway lighting is always selected such that it is only as strong as absolutely required to ensure a safe, trouble-free flight operation.

Converting Equation 2 yields the following for the intensity dimming:

D=(Et*RVR²)/(I₀[RVR]*ê((In0.05*RVR)/MOR)) (Equation 3)

Using the sought for target value of the runway visual range RVR_{ZIEL} for the RVR allows the calculation of an intensity dimming D_{OPT} which changes depending on the MOR and background brightness and describes the optimal intensity adjustment for the given runway lighting system taking into account the meteorological optical range and the daylight conditions with respect to the background brightness,

D_{OPT}=(Et*RVR_{ZIEL}²)/(I₀[RVR_{ZIEL}]*ê((In0.05*RVR_{ZIEL})/MOR)) (Equation 4)

Based on safety considerations, different target values can be used for the RVR.

For example, it is conceivable to use the minimum RVR values according to CAT I to CAT IIIb (ICAO Annex 6—Operation of Aircraft) directly or with a safety factor applied.

Also, the determined intensity dimming D_{OPT} can be increased by a safety factor. Given the possibility of continuous adjustment of the lighting intensity, the intensity dimming should be rounded off to the next highest intensity step in any event.

In every case, it is not prejudicial to safety to set the target value for the RVR to the minimum upper limit for RVR determination of 1500 m recommended by the ICAO (ICAO Manual of Runway Visual Range Observing and Reporting Practices, Doc. 9328-AN/908).

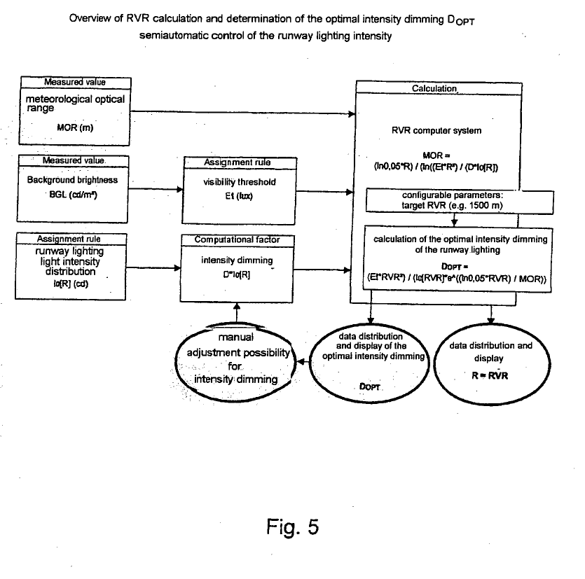

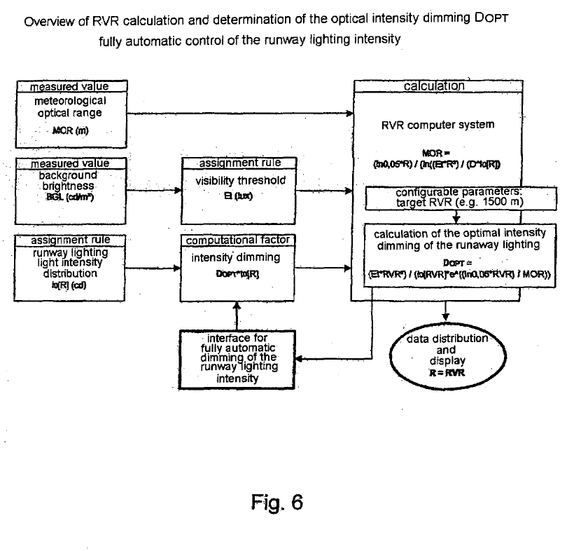

The determined optimal factor for the intensity dimming of the runway lighting system can now be suggested to the ATC personnel via a corresponding display system for tracking (see FIG. 5) or can be transmitted directly to the runway lighting system via a suitable interface of the RVR computer system for fully automatic tracking (see FIG. 6).

In both cases, the adjustment of the runway lighting intensity can be optimized based on environmental parameters that are known and acquired by measurement. An overly intense setting of the lighting intensity is prevented, energy consumption and the risk of dazzling effects are minimized, and the useful life of the lighting means is extended.

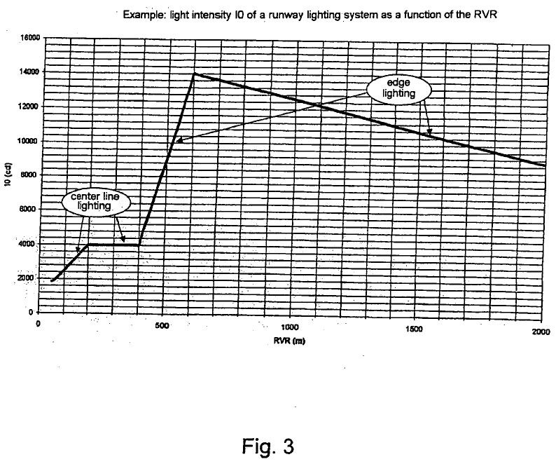

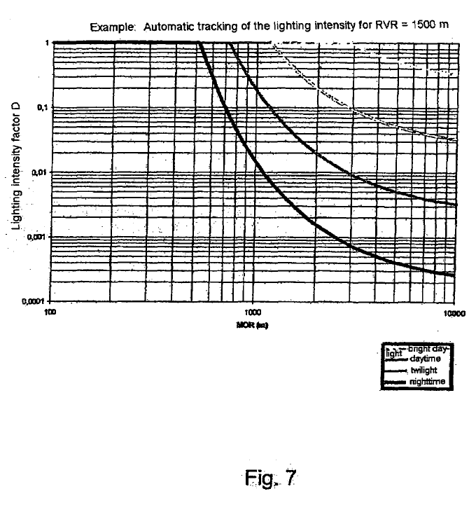

FIG. 7 shows the resulting lighting intensity dimming D_{OPT} as a function of the measured MOR based on the assignment example for I₀[RVR] according to FIG. 3 for the selected background brightness situations: nighttime, twilight, daytime, bright daylight, assuming the use of a target value of 1500 m for the RVR.

It should also be taken into consideration for implementing the method that lighting intensities below 3% are not recommended by the ICAO because of the increasing red component in the spectrum of the runway lighting system. Therefore, the following must be true for the results of Equation 4:

when D_{OPT}<0.03, then D_{OPT}=0.03 (Equation 5)

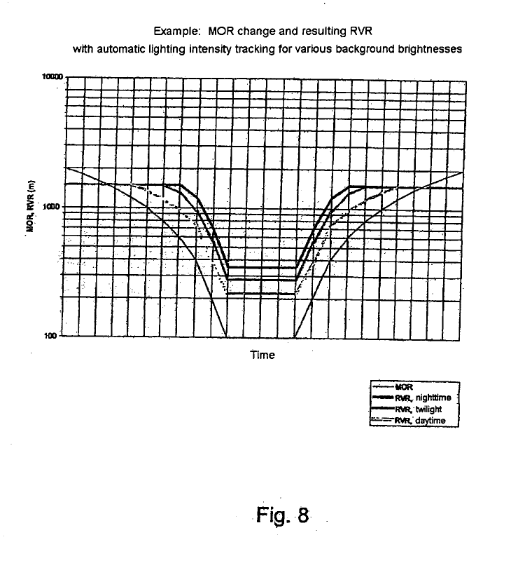

To illustrate the manner in which the method functions, FIG. 8 shows an example of a time curve of the MOR and the resulting RVR for different background brightnesses with automatic intensity tracking of the runway lighting.

Whenever possible, the automatic tracking of the runway lighting intensity keeps the RVR constant at the target value of 1500 m. After 100% lighting intensity is reached, the influence of the further decreasing MOR also impacts the RVR.

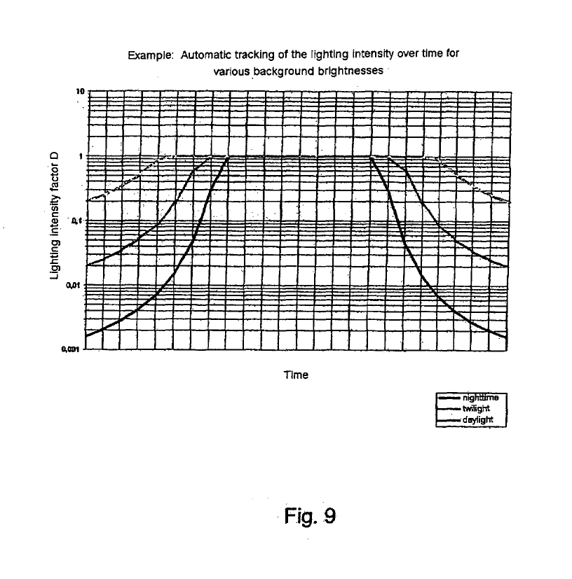

FIG. 9 shows the associated curve of the lighting intensity dimming for the same phase (without taking into account Equation 5). Depending on the background brightness, the lighting intensity dimming D_{OPT} sooner or later reaches a value of 1 corresponding to a lighting intensity of 100% after the optimized curve.

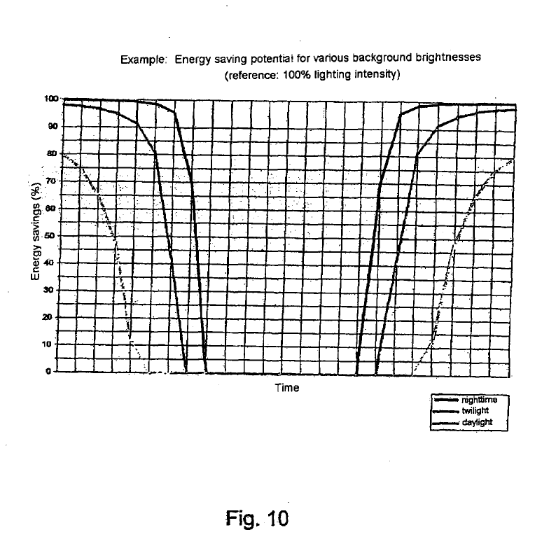

FIG. 10 shows the energy saving potential for the same phase based on the automatic tracking of the runway lighting intensity. However, the energy saving potential based on the condition according to Equation 5 cannot exceed a value of 97% in practical implementation.

While the foregoing description and drawings represent the present invention, it will be obvious to those skilled in the art that various changes may be made therein without departing from the true spirit and scope of the present invention.

1-8. (canceled)

9. A method for determining and tracking the runway lighting intensity based on the determination of an optimal lighting intensity for a target value of the runway visual range RVR taking into account the runway-specific parameters of the lighting system, the meteorological optical range, and the background brightness, comprising the steps of:
providing the measured values for the meteorological optical range MOR and the background brightness and the runway-specific and lighting system-specific light intensity distribution of the lighting system taking into account the observation angle of the pilot on approach, and a minimum runway lighting intensity to a computer system;
determining a visibility threshold within the computer system based on the measured background brightness;
calculating an optimal factor for the intensity dimming of the runway lighting within the computer system using the measured MOR, the calculated visibility threshold, the runway-specific and lighting system-specific light intensity distribution of the lighting system taking into account the observation angle of the pilot on approach, and the minimum runway lighting intensity, which optimal factor ensures an RVR corresponding to the target value insofar as permitted by the environmental parameters; and
providing the determined optimal factor for the intensity dimming by way of a suitable data interface and/or display for determining and tracking the runway lighting intensity.

10. The method according to claim 9, wherein the conversion of the measured background brightness into the visibility threshold Et is carried out in a continuous manner.

11. The method according to claim 9, wherein the calculated optimal factor for the intensity dimming of the runway lighting system is transmitted directly to the runway lighting system via a data interface for fully automatic tracking.

12. The method according to claim 9, wherein the calculated optimal intensity dimming for the runway lighting system is presented to the ATC personnel via a corresponding display as a suggestion, and the tracking of the runway lighting intensity is carried out manually.

13. The method according to claim 9, wherein the tracking of the runway lighting intensity is carried out in a continuous manner.

14. The method according to claim 9, wherein the target value for the RVR is freely configured.

15. The method according to claim 9, wherein the minimum runway lighting intensity is freely configured.

16. The method according to claim 9, wherein the optimal intensity dimming is rounded off to the next highest possible intensity step when the runway lighting intensity is adjusted in a continuous manner.
